(19) United States
(12) Patent Application Publication
(10) Pub. No.: US 2009/0044700 A1
(43) Pub. Date: Feb. 19, 2009

(54) Process for Producing Injectable Solutions by Degassing Liquids and the Use Thereof for Stabilizing Oxidation-Sensitive Substances

(76) Inventors: Francois Dietlin, Paris (FR); Daniele Fredj, Crans-Montana (CH)

Correspondence Address: HEDMAN & COSTIGAN P.C., 1185 AVENUE OF THE AMERICAS, NEW YORK, NY, 10036, US

(21) Appl. No.: 12/086,216

(22) PCT Filed: Dec. 5, 2006
(86) PCT No.: PCT/FR2006/002654

§ 371 Date: Jul. 3, 2008

(30) Foreign Application Priority Data
Dec. 6, 2005 (FR) 0512366

(51) Int. Cl. B01D 19/00; B01J 19/10

(52) U.S. Cl. 95/30

(57) ABSTRACT

The invention relates to chemistry, in particular to pharmaceutical engineering, and more specifically to a method for degassing, in particular, to deoxygenating liquid, in particular aqueous media consisting in simultaneously in agitating an inert gas, in exposing a solution to a deep vacuum and to a ultrasound action and in heating it with a temperature ranging from 35 to 60° C. The inventive method makes it possible to obtain an aqueous medium whose oxygen content ranges from 4 to 0.4 mg/l for producing stable aqueous solutions of food or pharmaceutical products.

The present invention relates to the field of chemistry and more particularly of pharmaceutical engineering.

Its subject is more especially a method for degassing, in particular for deoxygenating, liquids containing a phenolic substance and more particularly paracetamol solutions for injection in order to bring their oxygen content to extremely low values, often less than 1 mg/l.

Its subject is more specifically the use of such a method for stabilizing oxidation-sensitive organic compounds such as paracetamol.

It is known that the stability of certain substances of a phenolic nature, such as paracetamol or analogs, when they are in solution or in suspension in solvents, in particular in water, is affected by the presence of oxygen still present in the solvent.

The possibility of ensuring the stability of dobutamine solutions in an aqueous medium by supplementing them with ascorbic acid is described in particular in French patent 2740338. This method nevertheless requires the addition of large quantities of ascorbic acid, which inevitably leads to side effects because of the pharmacological activity of ascorbic acid or of its derivatives.

The problem exists for solutions of phenolic molecules such as adrenaline, noradrenaline or paracetamol. Various methods have already been described in this regard for ensuring stability. Accordingly, European patent EP 0858329 in the name of the applicant describes a method for stabilizing aqueous solutions of phenolic molecules which consists in deoxygenating such a solution.

To deoxygenate an aqueous solution, several means are possible:
Heating the water to a temperature close to boiling, which has the effect of reducing the solubility of the dissolved gases, including oxygen. However, this technique is sometimes imperfect and difficult to use at the production sites or on a large scale.
Placing the solution under a high vacuum. However, despite its efficiency, this method requires maintaining the vacuum for a prolonged period which may be several hours. This method is therefore unsuitable for the requirements of production.
Bubbling an inert gas such as nitrogen or argon. It is the method described in international patent application WO 00/07231 in the name of the Applicant. This patent application describes the possibility of reducing the oxygen content of a paracetamol solution to less than 1 mg/ml. A low oxygen content is made necessary because of the fact that the reoxidation of the phenolic molecules is possible from a content as low as 2 mg/l, even in the presence of antioxidants.

This method additionally requires, in addition to the bubbling of an inert gas, maintaining the solution under vacuum, once packaged, because the depression thus produced promotes the removal of traces of oxygen still present in the solution.
The use of ultrasound, knowing that this technique is used in particular for degassing solutions or solvents intended for high performance liquid chromatography. However, this technique is not very efficient in particular because the vibration caused by the ultrasound at the water/air interface promotes the redissolution of gases.

None of the methods already described was therefore totally satisfactory and the degassing technique consequently needed to be improved, in particular as regards paracetamol solutions for injection.

This method was substantially solved by the new method which is the subject of the present invention. This method for stabilizing aqueous solutions or suspensions for injection of phenolic substances is characterized in that it combines, simultaneously and by a specific procedure, at least two of the degassing methods previously described by obtaining a synergistic effect, namely heating and/or placing under high vacuum and/or bubbling of an inert gas and/or use of ultrasound. The content of residual gases and in particular of oxygen in the medium may vary from 0.4 to 4 mg/l. Thus, the efficiency of this method, through its simple and rapid implementation, surprisingly results in lower contents of residual gases and especially of oxygen but which are more rapidly obtained. A synergistic effect is therefore observed and not a solely additive effect of the various means used.

Another advantage of the method according to the invention lies in the fact that it may be applied to any volume of solution and in that it finds its application in the degassing of large-volume tanks used for the bulk preparation of a large volume of solution of oxidation-sensitive substances, such as for example a phenolic substance such as paracetamol.

Another advantage also lies in the fact that the method according to the invention may be carried out only after distributing into bottles, before stoppering and optionally crimping the bottles containing the solution. It is very rapid and easy to apply given that the duration of exposure to the ultrasound is very short.

Depending on the volume of solution and the size of the container to be degassed, it is advisable to adjust the power of the ultrasound generator and to use the appropriate ultrasound transducer (sonotrode).

According to the currently preferred features of the method according to the invention, an ultrasound generator operating at a frequency varying from 20 to 100 kHz is used, and the power may be set between 0 and 130 watts according to the volume of the container, as for example for small bottles.

Sonotrodes having a diameter of the order of 1 mm to 25 mm and, for example for 100 ml bottles, of 3 mm×45 mm or of 6 mm×60 mm delivering power varying from 0 to 100 W and more specifically from 15 to 50 W, specifically from 15 to 25 W or from 35 to 50 W depending on the size of the sonotrodes, are preferably used.

The duration of exposure to ultrasound may vary from 10 seconds to 120 seconds and preferably from 15 seconds to 60 seconds.

The procedure is preferably carried out under vacuum using an appropriate vacuum pump such as a vane pump. The initial or residual oxygen content is measured with the aid of an oxygen meter operating according to the Clark principle giving the value of the oxygen content in mg/l. The scale is calibrated between a point zero (reducing solution) and the content at oxygen saturation of distilled water, taking into account the temperature of the medium and the atmospheric pressure. The oxygen content is calculated using a chart as a function of the temperature and the pressure. The temperature of the medium is measured with the aid of an electronic thermometer to within 1/10^{th} of a degree.

The solutions or dispersions, which are in particular aqueous and contain oxidizable substances, are distributed into containers or into glass bottles for example of 125 ml filled to 100 ml.

In a first instance, the efficiency of the method according to the invention was determined on solutions of distilled water containing no oxygen-sensitive active ingredient in order to determine the residual oxygen concentrations obtained by virtue of the degassing technique according to the invention.

In a second instance, the method according to the invention was carried out with the same features, using an aqueous solution of an oxidation-sensitive substance such as a phenolic substance such as adrenaline, adrenalone, ephedrine, epinephrine, suprenaline, adrenochrome, propaphenone, dobutamine or an aqueous-aromatic substance such as for example phenothiazine, riboflavin, tetrahydro-10-aminoacridine, anthracyclines, tetracyclines and analogs and especially aqueous solutions of paracetamol. The latter preferably have a concentration varying from 0.5 to 10 g per 100 ml and more particularly from 0.5 to 2.5 g per 100 ml.

The quantity of oxygen removed by the method according to the invention is a direct function of the period of exposure to the ultrasound and of the period under vacuum. It is also a direct function of the ultrasound power delivered. It also depends on the temperature of the medium. The residual content of oxygen after use is generally between 0.4 and 0.6 mg/l.

No significant difference is observed in the residual oxygen contents regardless of the inert gas used such as for example nitrogen, argon, xenon or any other rare gas. It is also possible to carry out the procedure by placing the sonotrode outside the bottle with the same results.

The following examples are intended to illustrate the invention. They do not limit it in any way.

### EXAMPLE I

### Action of the Combination of Vacuum and Ultrasound

Materials

Ultrasound generator operating at 20 KHz power and adjustable between 0 and 130 watts.

Ultrasound transducers (sonotrodes) of diameter 3 mm×45 mm or 6 mm×60 mm delivering powers of 15-25 W or 35-50 W, respectively. A 2-stage vacuum pump delivering a maximum vacuum of 3×10⁻³ mbar is also used. The oxygen content is determined with the aid of an oxygen meter operating according to the Clark principle giving the value of the oxygen content in mg/l. The scale is calibrated between a point zero (reducing solution) and the content at oxygen saturation of distilled water, taking into account the temperature and the atmospheric pressure. This content is given by a chart (oxygen content as a function of the temperature and the pressure).

The device is completed by an electronic thermometer to within 1/10^{th} of a degree. The liquid is distributed into 125 ml glass bottles filled to 100 ml.

Methods

The bottles are filled to 100 ml with distilled water in which air has been bubbled until an equilibrium of oxygen content is reached. The sonotrode is introduced into the bottle by a hole made in the elastomeric stopper, as well as an infusion needle intended for placing the bottle under vacuum and connected for this purpose to the vacuum pump by a flexible tubing designed to withstand the vacuum without collapsing. The whole is designed so as to ensure that the bottle is sealed relative to the exterior. The vacuum alone, the ultrasound alone at the 2 powers delivered by two different sonotrodes and the vacuum+ultrasound combination are tested. The exposure times are 15 sec, 30 sec and 1 min.

Immediately after this treatment, the vacuum inside the bottles is broken by a covering consisting of an inert gas such as argon.

After opening the stopper, the oxygen meter probe is introduced into the bottle and the measurement is carried out.

This covering is intended to avoid recontamination with oxygen and ensures an exact measurement of the oxygen.

Results

Temperature of the water: 25.0-25.1° C.

Oxygen content of the water at the start: 8.35-8.40 mg/l

OXYGEN CONTENT (mg/l)

| | 15 sec | 30 sec | 1 min |
|---|---|---|---|
| Ultrasound 15-20 W | 7.2 | 6.9 | 6.75 |
| Ultrasound 35-45 W | 6.85 | 6.45 | 6.25 |
| Vacuum alone | 7.9 | 7.75 | 7.45 |
| Ultrasound 15-20 W + vacuum | 2.85 | 2.5 | 2.15 |
| Ultrasound 35-45 W + vacuum | 2.6 | 2.05 | 1.35 |

The quantity of oxygen removed is a direct function of the duration of exposure both to the ultrasound and to the vacuum. It is also a direct function of the ultrasound power delivered.

Taking as an example a 30 sec treatment, it is observed that the vacuum alone removes 0.75 mg/l of oxygen, that the ultrasound at low power removes 1.6 mg/l of oxygen, while the combination of the 2 agents removes 6 mg/l of oxygen, that is, more than double compared with the mere additivity of these 2 methods. This synergy is observed for all the durations and all the powers.

### EXAMPLE II

### Combination of Vacuum, Ultrasound and Heating

Materials and Methods

These are identical to those of the preceding trial but the temperature of the water is varied. The measurement is carried out after equilibration of the temperature at 40° C., 45° C. or 50° C.

Result

Temperature of the water at the start: 21.5-21.6° C.

Oxygen content of the water at the start: 8.7-8.9 mg/l

OXYGEN CONTENT (mg/l)

| | Duration of exposure | | |
|---|---|---|---|
| Conditions tested | 15 sec | 30 sec | 1 min |
| Ultrasound 15-20 W - 40° C. + vacuum | 1.7 | 1.5 | 1.05 |
| Ultrasound 15-20 W - 45° C. + vacuum | 1.3 | 1.15 | 0.9 |
| Ultrasound 15-20 W - 50° C. + vacuum | 1.0 | 0.7 | 0.5 |
| Ultrasound 35-45 W - 40° C. + vacuum | 1.55 | 1.25 | 0.75 |
| Ultrasound 35-45 W - 45° C. + vacuum | 1.4 | 0.75 | 0.5 |
| Ultrasound 35-45 W - 50° C. + vacuum | 1.3 | 0.7 | 0.4 |

The effect of heating is clearly demonstrated.

In the specific case of an aqueous paracetamol solution at 1 g/100 ml, an ultrasound current is applied under a tension of 35 to 45 W while applying the vacuum.

The trials show that after 15 sec the oxygen content is 1.3 mg/l and that after 30 sec the oxygen content in the solution is 0.6 mg/l.

The method is therefore equally effective in the presence of a dissolved substance.

WITH PARACETAMOL 1 g/100 ml

Duration of exposure

| Conditions tested | 15 sec | 30 sec |
|---|---|---|
| Ultrasound 45-55 W - 45° C. + | 1.3 | 0.6 |
| vacuum | | |

Similar trials were performed with paracetamol solutions at other concentrations (2 g or 5 g/100 ml) with very similar results. The same is true with Dopamine or Noradrenaline solutions.

### EXAMPLE III

### Combination of Bubbling of an Inert Gas and Ultrasound

The materials are identical to those of the preceding trials.

Argon bottle with microbubbling device of diameter 20 mm introduced into the bottle.

Gas flow rate: about 2 l/min.

Methods

The bottles are filled to 100 ml with distilled water in which air has been bubbled until equilibrium of oxygen content is obtained. The sonotrode is introduced into the bottle as well as the tubing equipped with the sintered device. The system is not sealed, so as to allow the excess argon and the dissolved gases to escape.

The effects of bubbling argon alone and of the bubbling+ultrasound at 35-45 W combination are tested. The exposure times are 15 seconds, 30 seconds and 1 minute.

Immediately after the treatment, the oxygen meter probe is introduced into the bottle and the measurement is performed.

Results

Temperature of the water: 21.3-21.4° C.

Oxygen content of the water at the start: 8.50-8.80 mg/l

OXYGEN CONTENT (mg/l)

| | Duration of exposure | | |
|---|---|---|---|
| Conditions tested | 15 sec | 30 sec | 1 min |
| Bubbling of argon alone | 6.85 | 5.70 | 4.45 |
| Ultrasound 15-25 W + | 5.85 | 4.60 | 2.70 |
| bubbling of argon | | | |
| Ultrasound 35-45 W + | 4.90 | 3.60 | 1.30 |
| bubbling of argon | | | |

The influence of the bubbling of argon is evident.

### EXAMPLE IV

### Combination of Bubbling, Ultrasound and Heating

Materials and Methods

The procedure for the trials is identical to that of the preceding trial, but varying the temperature of the water. The measurement is carried out after equilibration of the temperature of the water heated to 40° C.-45° C. and 50° C.

Results

Temperature of the water at the start: 20.2-20.4° C.

Oxygen content of the water at the start: 8.80-9.10 mg/l

OXYGEN CONTENT (mg/l)

| | Duration of exposure | | |
|---|---|---|---|
| Conditions tested | 15 sec | 30 sec | 1 min |
| Ultrasound 15-20 W - 40° C. + | 5.2 | 4.3 | 1.9 |
| bubbling of argon | | | |
| Ultrasound 15-20 W - 45° C. + | 4.5 | 3.05 | 1.3 |
| bubbling of argon | | | |
| Ultrasound 15-20 W - 50° C. + | 4.05 | 2.2 | 0.9 |
| bubbling of argon | | | |
| Ultrasound 35-45 W - 40° C. + | 4.3 | 2.9 | 1.1 |
| bubbling of argon | | | |
| Ultrasound 35-45 W - 45° C. + | 3.75 | 2.75 | 0.9 |
| bubbling of argon | | | |
| Ultrasound 35-45 W - 50° C. + | 2.7 | 0.75 | 0.45 |
| bubbling of argon | | | |

The efficiency of the method is further increased when the sonotrode is kept in the gaseous stream.

No significant difference was observed in the residual oxygen contents obtained by bubbling argon or nitrogen.

The invention finds its use in the production of pharmaceutical dosage forms, especially of solutions for injection containing, as active ingredient, a therapeutic substance having a phenolic structure, such as paracetamol. The method according to the invention also serves for the production of stable aqueous solutions or dispersions of food products which can deteriorate in oxygen such as fatty emulsions, dispersions of carotenoids or solutions of phospholipids.

The solutions or dispersions thus obtained are distributed into ready-to-use hermetically stoppered pouches or bottles.

1. A method for degassing aqueous solutions or dispersions of oxygen-sensitive phenolic substances, comprising subjecting the liquid both to the action of ultrasound and to at least one action selected from vacuum and microbubbling, to obtain a residual content of gas, of the order of 0.4 to 4 mg/l.

2. The method for degassing aqueous solutions or dispersions of claim 1, wherein an additional phase of heating to a temperature of 30 to 60° C. is combined with the treatments to which the liquid was subjected.

3. The method for degassing aqueous solutions or dispersions of claim 2, wherein the heating is performed between 40 and 50° C.

4. The method for degassing aqueous solutions or dispersions of claim 1, in which wherein the microbubbling is performed by bubbling a gas different from that whose removal is started.

5. The method for degassing aqueous solutions or dispersions of claim 4, wherein the bubbling gas is argon or nitrogen.

6. The method for degassing aqueous solutions or dispersions of claim 1, wherein the sonotrodes (ultrasound transducers) deliver a power varying from 0 to 130 W.

7. The method for degassing aqueous solutions or dispersions of claim 6, wherein the power delivered by the sonotrodes varies from 15 to 50 W.

8. The method for degassing aqueous solutions or dispersions of claim 1, wherein the frequency of the ultrasound generator varies from 20 to 100 kHz.

9. The method for degassing aqueous solutions or dispersions of claim 1, wherein the duration of exposure to ultrasound varies from 10 seconds to 120 seconds, depending upon the size of the container and the surface of the sonotrode.

10. The method for degassing aqueous solutions or dispersions of claim 1, wherein the duration of exposure to ultrasound varies from 30 seconds to 1 minute.

11. The method for degassing aqueous solutions or dispersions of claim 1, wherein the residual content of oxygen in the aqueous medium varies, depending upon the period of exposure to ultrasound, to heat and/or to bubbling of inert gas, from 4 mg to 0.4 mg/l.

12. The method for degassing aqueous solutions or dispersions of claim 1, wherein said method has the effect of allowing complete deoxygenation of the medium of between 1.0 and 0.4 mg/l.

13-15. (canceled)

16. The method of claim 7 wherein the power delivered is from 35 to 50 W.

17. The method of claim 1 wherein gas being removed is oxygen.

18. The method of claim 1 wherein the oxygen-sensitive phenolic substance is food pharmaceutical product containing a phenolic compound.

19. The method of claim 1 for degassing a stable aqueous solution of 0.5 to 10 g/100 ml of paracetamol.
